(19) United States
(12) Patent Application Publication
(10) Pub. No.: US 2009/0060499 A1
(43) Pub. Date: Mar. 5, 2009

(54) APPARATUS AND METHOD FOR MONITORING QUALITY OF OPTICAL SIGNAL

(75) Inventors: Hwan-seok Chung, Daejeon (KR); Sang-soo LEE, Daejeon (KR); Sun-hyok CHANG, Daejeon (KR); Kwang-joon KIM, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics & Telecommunications Research Institute, Daejeon (KR)

(21) Appl. No.: 12/060,660

(22) Filed: Apr. 1, 2008

(30) Foreign Application Priority Data
Sep. 3, 2007 (KR) 1020070089206

(51) Int. Cl. H04B 10/08

(52) U.S. Cl. 398/34

(57) ABSTRACT

An apparatus and method for monitoring quality of an optical signal in an optical network based on wavelength division multiplexing optical transmission technology are provided, which are capable of monitoring the quality of an optical signal with higher accuracy. The apparatus includes: a signal extractor extracting an optical signal having a specific wavelength from input optical signals; an optical-electrical converter converting the extracted optical signal having the specific wavelength into an electrical signal; an overhead parser extracting a part of an overhead of the electrical signal to parse whether or not the quality of the signal is degraded; and a controller monitoring the quality of the optical signal according to the parsing result of the extracted overhead and restoring the optical signal whose quality is lower than a predetermined reference value.

### CROSS REFERENCE TO RELATED APPLICATIONS

This application claims priority from Korean Patent Application No. 10-2007-0089206, filed on Sep. 3, 2007, the disclosure of which is incorporated herein in its entirety by reference.

### BACKGROUND OF THE INVENTION

1. Field of the Invention

The present invention relates to an optical network based on wavelength division multiplexing optical transmission technology and, more particularly, to an apparatus and method for monitoring quality of an optical signal at each node in an optical network.

This work was supported by the IT R&D program of Ministry of Information and Communication (MIC)/Institute for Information Technology Advancement (IITA) [2006-S-059-02, ASON Based Metro Photonic Cross-Connect Technology].

2. Description of the Related Art

Wavelength division multiplexing (WDM) optical transmission technology has been coming forth as a solution to the sharp increase in demand for transmission capacity. The WDM optical transmission technology makes it possible to simultaneously transfer a plurality of wavelengths through a single optical fiber. For example, assuming that one wavelength channel simultaneously transfers 50 wavelengths at a rate of 10 Gb/s, the total transfer rate amounts to 500 Gb/s. As can be seen from this example, the WDM optical transmission technology is very useful in high-capacity data transmission.

Meanwhile, in order to increase efficiency and variability of an optical network using the WDM optical transmission technology, technology for adding and dropping a wavelength channel at a network node has become necessary. Reconfigurable optical add-drop multiplexer (ROADM) technology makes it possible not only to increase the efficiency of the optical network but also to make a more economical use of network resources, etc. The use of the ROADM technology allows a certain channel to be added or dropped at a certain node, so that the network can be operated with higher efficiency.

Meanwhile, in order to further increase the efficiency of the ROADM technology, along with the development of the ROADM technology, an optical network topology is developing to a simple point-to-point type in which transmission between both nodes is performed through fixed lines, as well as a ring type or a mesh type in which a network can be reconfigured dynamically if necessary.

At this time, in an optical/electrical/optical (O/E/O) cross-connector, which performs optical-to-electrical conversion and then electrical-to-optical conversion on all pieces of information at each network node, electrical information processing acts as a bottleneck when transmission capacity of data increases. Furthermore, the expenses for the electrical information processing are proportional to the transmission capacity. Meanwhile, the O/E/O cross-connector can not only reduce operating expenses of a system but also simplify a structure of the system by passing an optical signal, which is not split/combined at the node, without the optical-to-electrical conversion, and by performing the optical-to-electrical conversion and electrical-to-optical conversion on only an optical signal which will be split/combined.

In the case in which the information is transferred without the O/E/O conversion in the optical network, any electrical signal can be converted to an optical signal when transferred, regardless of a transfer rate of a channel, a frame format of a signal, etc., However, unlike the O/E/O cross-connector that regenerates signals at all nodes, a network using an optical/optical/optical (O/O/O) cross-connector may have a degraded optical signal because it does not regenerate the optical signal at any intermediate node. The network is therefore limited in its transmission distance and extension. Thus, the O/O/O network requires a means for monitoring degradation in quality of the optical signal and restoring a degraded optical signal to ensure a reliable and extensible optical cross-connector.

A method for monitoring optical power of an optical signal has traditionally been proposed to monitor quality of the optical signal. However, this method has mainly been used to control power between channels and to determine whether or not an optical signal exists. As another method, the quality of the optical signal can be determined according to a bite error rate (BER), which has an effect on optical characteristics and system performance in a system environment. In practice, a relation between OSNR and BER can be estimated by measuring an optical signal to noise ratio (OSNR). However, since BER is affected by chromatic dispersion, polarization mode dispersion (PMD), nonlinearity, etc. in addition to OSNR in an actual network, OSNR cannot be estimated only from an accurate BER. Therefore, it is difficult to accurately determine the quality of the optical signal.

### SUMMARY OF THE INVENTION

The present invention provides an apparatus and method for monitoring a quality of an optical signal at each node in an optical network, capable of monitoring the quality of the optical signal with higher accuracy.

Further, the present invention provides an apparatus and method for monitoring a quality of an optical signal at each node in an optical network, capable of improving the quality of an optical signal in an optical cross-connector and enhancing reliability of the optical network.

Additional aspects of the invention will be set forth in the description which follows, and in part will be apparent from the description, or may be learned by practice of the invention.

The present invention discloses an apparatus for monitoring quality of an optical signal at each node of a wavelength division multiplexing optical transmission system using a part of the optical signal which is input.

The present invention also discloses an optical cross-connector including the apparatus for monitoring quality of an optical signal at each node of a wavelength division multiplexing optical transmission system using a part of the optical signal which is input.

The present invention also discloses a method for monitoring quality of an optical signal at each node of a wavelength division multiplexing optical transmission system, which includes: extracting an optical signal having a specific wavelength from input optical signals; converting the extracted optical signal having the specific wavelength into an electrical signal; and monitoring and restoring the quality of the optical signal according to the electrical signal.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 is a block diagram illustrating the configuration of an apparatus for monitoring a quality of an optical signal in accordance with an exemplary embodiment of the present invention.

FIG. 2 is a block diagram illustrating the configuration of an apparatus for monitoring a quality of an optical signal in accordance with an exemplary embodiment of the present invention.

FIG. 3 is a table showing the type and use of an overhead of an SDH signal.

FIG. 4 is a block diagram illustrating the configuration of an optical cross-connector according to an exemplary embodiment of the present invention.

FIG. 5 is a block diagram illustrating the configuration of an optical cross-connector according to an exemplary embodiment of the present invention.

FIG. 6 is a flow chart illustrating a method for monitoring a quality of an optical signal according to an exemplary embodiment of the present invention.

### DETAILED DESCRIPTION OF EXEMPLARY EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art.

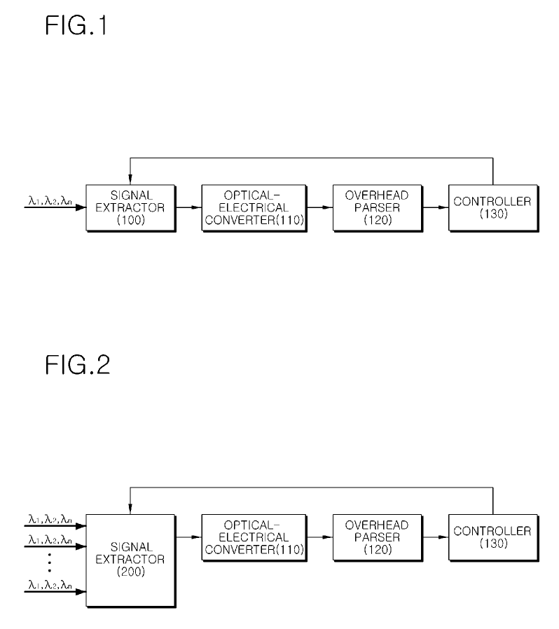

FIG. 1 is a block diagram illustrating the configuration of an apparatus for monitoring a quality of an optical signal in accordance with a first embodiment of the present invention. FIG. 2 is a block diagram illustrating the configuration of an apparatus for monitoring a quality of an optical signal in accordance with a second embodiment of the present invention.

The apparatus for monitoring a quality of an optical signal includes a signal extractor 100, an optical-electrical converter 110, an overhead parser 120, and a controller 130.

The signal extractor 100 extracts a signal having an arbitrarily selected specific wavelength from n input signals having wavelengths from λ₁ to λₙ. In the first embodiment, the signal extractor 100 is a wavelength variable filter. In the second embodiment, a signal extractor 200 may be an optical switch. The optical switch is a wavelength selective switch (WSS). The WSS can extract only a signal of an arbitrarily selected wavelength from signals of multiple wavelengths, which are input into one of multiple input ports. In FIG. 2, the signal extractor 200 is the optical switch. As illustrated in FIG. 2, in the case in which the signal extractor 200 is the optical switch, a single apparatus for monitoring a quality of an optical signal can monitor the qualities of optical signals, which are input into multiple input ports.

The optical-electrical converter 110 converts the optical signal of an arbitrary wavelength selected by the signal extractor 100 into an electrical signal. When such conversion is carried out using an additional radio frequency (RF) amplifier, intensity of the electrical signal can be properly adjusted.

The overhead parser 120 extracts a part of an overhead of a synchronous digital hierarchy (SDH) synchronous transfer module (STM) signal, which is converted and output by the optical-electrical converter 110, and then determines whether or not the quality of the optical signal is degraded.

In the relay section of a conventional SDH transmission network, a parity bit calculated by bit interleaved parity 8 (BIP-8) is added to 8 bits of a B1 byte when transferred, and transmission quality is measured using this B1 byte. As described above, in order to parse the B1 byte, the optical/electrical conversion is required. In the case of a conventional O/O/O transmission mode, it is not possible to parse the B1 byte in an optical receiving section of an intermediate node. Consequently, it is possible to parse the B1 byte only at a destination node at which data is received or regenerated. Thus, in the present invention, in order to solve this problem, a separate apparatus for monitoring a quality of an optical signal can extract only a signal of a specific wavelength, and check only the B1 byte of the overhead of the extracted signal having the specific wavelength. Thus, the quality of the optical signal can be determined exactly at a node at which the data is not received or regenerated.

The overhead parser 120 receives a frame signal input from the optical-electrical converter 110, descrambles the frame signal, and extracts the B1 byte which is obtained by BIP-8 calculation of a corresponding signal from the overhead.

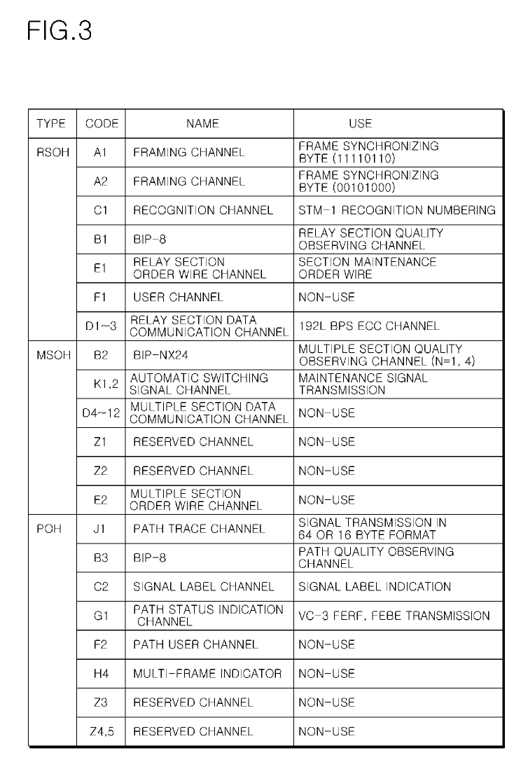

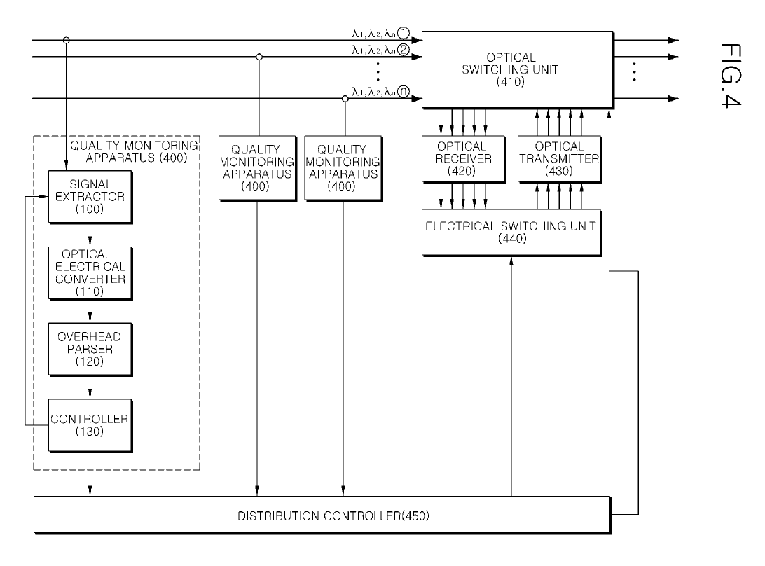

FIG. 3 is a table showing the type and use of an overhead of an SDH signal.

When an SDH signal is transmitted as a client signal in a wavelength division multiplexing (WDM) network, an overhead, which is not used as a part of a regenerator section overhead (RSOH) in the SDH signal, can be used as an overhead signal of an optical channel layer. As can be seen from FIG. 3, one byte is assigned as the B1 byte in order to monitor a quality of an SDH relay section as prescribed in ITU-T G.707 in the SDH optical transmission unit. This byte is a BIP-8 code using an even parity. Once scrambled, BIP-8 is placed at a position of the B1 byte of a present frame by calculating all bits of a previous STM-N frame. At this time, one frame is divided into 8 blocks, and the 8 blocks are subjected to parity checking. Results of the parity checking are stored in the 8 bits of the B1 byte, respectively. The SDH signal in which the B1 byte is included is transmitted to the next repeater. The next repeater performs the parity checking on the frame of the transmitted SDH signal again, compares the stored parity checking results with that of the frame of the transmitted SDH signal, and thereby checks whether or not an error exists in the transmitted SDH signal. The parity checking results performed by the corresponding repeater are transmitted to the next repeater through the B1 byte in the SDH signal again. In other words, it can be detected whether or not the error occurs in the relay section from information of the B1 byte of the overhead data.

The controller 130 can be realized by a microprocessor and a program stored in the microprocessor. In this exemplary embodiment, the controller 130 monitors the qualities of received optical signals according to results of the B1 byte parsed by the overhead parser 120, and controls the optical signals when the qualities are lower than a reference value such that the optical signal is restored. Meanwhile, the controller 130 can select a specific wavelength of the optical signal, the quality of which is predicted to be degraded, according to network monitoring information transmitted from a processor managing an overall network. The controller 130 provides information on the selected specific wavelength to the signal extractor 100. The controller 130 may control all wavelengths of input optical signals to be sequentially selected and their qualities to be monitored.

The controller 130 can check whether or not, and if so the reason for which, the quality of the optical signal is degraded, according to a parsing result of the B1 byte and the network monitoring information transmitted from the processor managing the overall network.

FIG. 4 is a block diagram illustrating the configuration of an optical cross-connector according to an exemplary embodiment of the present invention.

The optical cross-connector includes a quality monitoring apparatus 400 according to an exemplary embodiment of the present invention at the input of an optical signal, an optical switching unit 410, an optical receiver 420, an optical transmitter 430, an electrical switching unit 440, and a distribution controller 450.

The optical cross-connector switches an arbitrary signal, which is input into an input port, to an arbitrary output port. The optical switching unit 410 can switch the optical signal regardless of a modulation mode and a protocol. However, the optical switching unit 410 cannot restore a degraded optical signal. Thus, the quality monitoring apparatus 400 of the present invention separately monitors qualities of optical signals input into input ports. In this exemplary embodiment, the signal extractor 100 of the quality monitoring apparatus 400 employs a wavelength variable filter. Here, the quality monitoring apparatus 400 is assigned to each of the input ports \textcircled{1}, \textcircled{2} . . . \textcircled{n} of the optical cross-connector. In other words, the quality monitoring apparatus 400 monitors the quality of the optical signal input into the input port of the optical cross-connector, and outputs the monitor result to the distribution controller 450.

The optical receiver 420 regenerates an input optical signal, and outputs it to the electrical switching unit 440. The electrical switching unit 440 switches the regenerated optical signal, which is input from the optical receiver 420, and outputs it to the optical transmitter 430. The optical transmitter 430 outputs the regenerated optical signal to an output port of the optical switching unit 410.

Each quality monitoring apparatus 400 monitors the qualities of optical signals having wavelengths from λ₁ to λₙ input through each port according to each wavelength. At this time, the quality monitoring apparatus 400 can sequentially monitor the quality with respect to each wavelength, or selectively monitor with respect to a specific wavelength. The quality monitoring apparatus 400 outputs the monitor result to the distribution controller 450.

The distribution controller 450 estimates the status of each optical signal according to the quality monitor result of the optical signals input from each quality monitoring apparatus 400, and determines whether the optical signal input into the input port is output after regeneration via the optical receiver 420 and the electrical switching unit 440, or output after being switched only at the optical switching unit 410. The distribution controller 450 outputs the determination result to the electrical switching unit 440 and the optical switching unit 410.

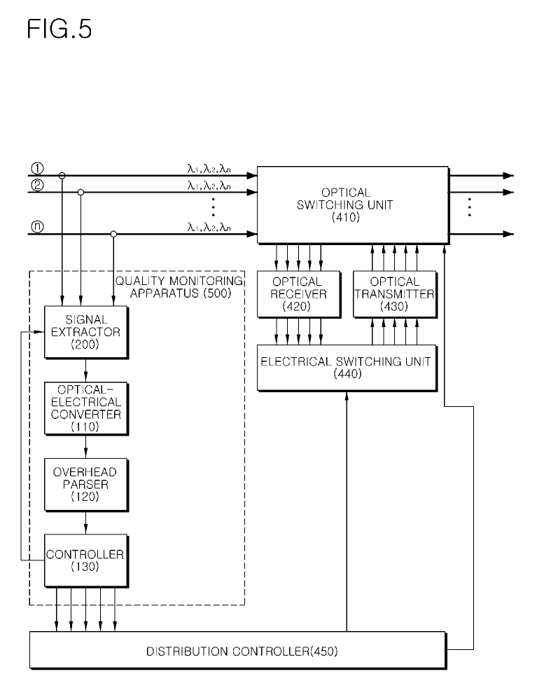

FIG. 5 is a block diagram illustrating the configuration of an optical cross-connector according to an exemplary embodiment of the present invention.

A signal extractor 200 of a quality monitoring apparatus 500 employs an optical switch, which makes it possible to extract a signal input into a specific port from signals input into a plurality of input ports. Thus, the optical cross-connector can be realized by one quality monitoring apparatus 500. At this time, the signal extractor 200 of the quality monitoring apparatus 500 can arbitrarily select one signal of a specific wavelength from the signals input into the input ports \textcircled{1}, \textcircled{2} . . . \textcircled{n}.

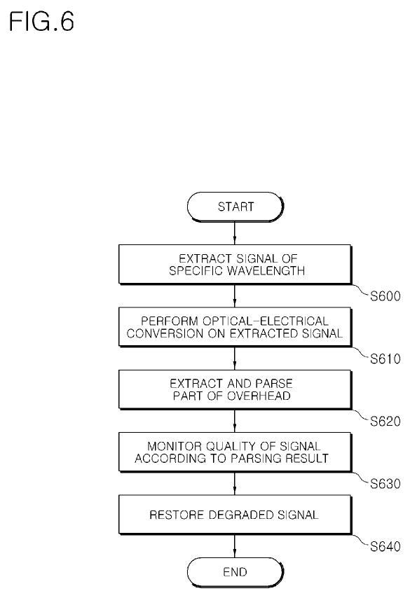

FIG. 6 is a flow chart illustrating a method for monitoring a quality of an optical signal according to an exemplary embodiment of the present invention.

First, a signal having a specific wavelength is extracted from input optical signals (S600). At this time, the specific wavelength may be sequentially or arbitrarily selected based on the respective wavelengths which the signals have. Then, the extracted signal having the specific wavelength is subjected to optical-electrical conversion (S610). A part of an overhead of the converted signal is extracted and parsed (S620). Here, the part of the overhead is preferably information on a B1 byte representing the quality monitor result of a relay section. Since the B1 byte is for monitoring the quality of the SHD relay section, degradation of the quality of the optical signal can be determined by parsing the B1 byte.

The quality of the optical signal is monitored, and then it is determined whether or not the quality of the optical signal has degraded to a point below a reference value according to the parsing results (S630). This determination is based on the result of determining whether or not a BER, i.e., a rate of the number of incorrectly received bits, which can be found from the information included in the B1 byte, exceeds the reference value. The signal having a quality which is lower than the reference value is subjected to removal of noise at the optical receiver 420 and the electrical switching unit 440, so that it can be restored and output to the outside (S640).

Meanwhile, the method for monitoring a quality of an optical signal can be drawn up using a computer program. Further, this program may be stored in computer readable media, and executed by reading of a computer. Examples of the media include magnetic recording media and optical recording media.

According to an optical quality monitoring apparatus of the present invention, the quality of a degraded optical signal at each node can be monitored with higher accuracy and restored, and thus reliability of the optical network can be improved.

Further, because there is no optical-electrical conversion of optical signals at intermediate nodes, network resources can be saved, operating expenses can be reduced, and the network can be operated in a more stable manner.

In addition, because degradation of the optical signal is monitored in real time, obstacles in the optical signal can be prepared for in advance.

As can be seen from the foregoing, the present invention can be used to monitor the quality of an optical signal in the field associated with an optical network that employs the WDM optical transmission technology.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. An apparatus for monitoring quality of an optical signal at each node of a wavelength division multiplexing optical transmission system using a part of the optical signal which is input.

2. The apparatus of claim 1, comprising:
a signal extractor extracting a part of the optical signal which is input;
an optical-electrical converter converting the extracted optical signal into an electrical signal;
a controller controlling to restore quality of the optical signal according to an analysis result of the electrical signal.

3. The apparatus of claim 2, further comprising an overhead parser extracting a part of an overhead of the electrical signal to parse whether or not the quality of the signal is degraded, wherein the controller controls to restore quality of the optical signal according to a parsing result of the extracted overhead.

4. The apparatus of claim 3, wherein the controller monitors the quality of the optical signal according to the parsing result of the extracted overhead and restores the optical signal whose quality is lower than a predetermined reference value.

5. The apparatus of claim 2, wherein the signal extractor extracts an optical signal having a specific wavelength.

6. The apparatus of claim 2, wherein the overhead parser extracts from the overhead a B1 byte indicating a quality monitor result of a relay section.

7. The apparatus of claim 2, wherein the signal extractor comprises a wavelength variable filter.

8. The apparatus of claim 2, wherein the signal extractor comprises an optical switch.

9. The apparatus of claim 2, wherein the signal extractor sequentially extracts input optical signals having a plurality of wavelengths one by one.

10. An optical cross-connector comprising the apparatus of claim 2.

11. A method for monitoring quality of an optical signal at each node of a wavelength division multiplexing optical transmission system, the method comprising:
extracting an optical signal having a specific wavelength from input optical signals;
converting the extracted optical signal having the specific wavelength into an electrical signal; and
monitoring and restoring the quality of the optical signal according to the electrical signal.

12. The method of claim 11, wherein the restoring of the quality of the optical signal according to the electrical signal comprises:
extracting a part of an overhead of the converted electrical signal to parse whether or not the quality of the signal is degraded; and
monitoring and restoring the quality of the optical signal according to the parsing result of the extracted overhead.

13. The method of claim 12, wherein the extracting of the optical signal having the specific wavelength comprises extracting data of a B1 byte indicating a quality monitor result of a relay section.

14. The method of claim 11, wherein the extracting of the optical signal having the specific wavelength comprises sequentially extracting input optical signals having a plurality of wavelengths one by one.

15. The method of claim 11, wherein the restoring of the quality of the optical signal according to the electrical signal comprises restoring the optical signal whose quality is lower than a predetermined reference value.
